(19) United States
(12) Patent Application Publication
(10) Pub. No.: US 2009/0197512 A1
(43) Pub. Date: Aug. 6, 2009

(54) Nozzle for co2 snow/crystals

(76) Inventors: Godehard Möller, Rheda-Wiedenbrück (DE); Andreas Michalske, Oelde (DE)

Correspondence Address: HEDMAN & COSTIGAN P.C., 1185 AVENUE OF THE AMERICAS, NEW YORK, NY, 10036, US

(21) Appl. No.: 11/663,604

(22) PCT Filed: Sep. 23, 2005
(86) PCT No.: PCT/EP05/10328

§ 371 Date: Mar. 23, 2007

(30) Foreign Application Priority Data
Sep. 28, 2004 (DE) 10 2004 047 050.2
Aug. 4, 2005 (DE) 10 2005 036 755.0

(51) Int. Cl. B24C 1/00; B05B 1/00

(52) U.S. Cl. 451/39; 239/589

(57) ABSTRACT

The invention relates to a nozzle 1 for the directed delivery of CO2 snow and compressed air, wherein a central region 5 of the nozzle 1 has at least a first discharge opening 6 which is designed to produce a core jet 2 of CO2 snow at ultrasonic speed, wherein the central region 5 of the nozzle 1 is surrounded by a peripheral region 7 which has several second discharge openings 8 which are arranged around the first discharge opening 6 and are designed to produce a mantle jet 3, surrounding the core jet 2, of air, preferably compressed air at a lower speed than the core stream 2, wherein the mantle jet 3 travels in the same direction as the core jet 2, and a method for the treatment, in particular cleaning, with CO2 snow of a workpiece to be coated, wherein a core jet 2 of CO2 snow is directed at a speed of more than 200 m/s with a mantle jet 3, surrounding the core jet 3, of air or compressed air, onto the workpiece, wherein the mantle jet 3 travels at a lower speed than the core jet 2.

The invention relates to a nozzle for CO2 snow. In particular the invention relates to a nozzle for the directed delivery of CO2 snow, in particular for the cleaning of workpieces.

Before a workpiece is coated it is cleaned and dirt is removed. In the past the use of CO2 snow or crystals as cleaning agent in a jet has also been considered.

In DE 19926119 C2 a jet tool is described for producing a jet of CO2 snow to clean Microsystems or precision engineering parts. With this jet tool CO2 snow is produced in a capillary tube and mixed with a support jet at ultrasonic speed. The complete jet produced in this way thus contains CO2 particles and is used to clean hardware such as a microchip.

The jet tool from the state of the art cannot be used to extensively clean workpieces in a coating device. In particular a capillary tube arrangement allows only a very small throughput of CO2 snow and is thus not suitable for broad industrial use.

An object of the present invention was therefore to provide a nozzle for cleaning with CO2 snow and air which satisfies the requirements of industrial-scale cleaning. A further object of the invention is to provide a method for the treatment, in particular for the cleaning, with CO2 snow of a workpiece that is to be coated.

The object is achieved by a nozzle for the directed delivery of CO2 snow and compressed air, wherein a central region of the nozzle has at least a first discharge opening which is designed to produce a core jet of CO2 snow at ultrasonic speed, wherein the central region of the nozzle is surrounded by a peripheral region which has several second discharge openings which are arranged (preferably symmetrically) around the first discharge opening and are designed to produce a mantle jet, surrounding the core jet, of air, preferably of compressed air at a lower speed than the core stream, wherein the mantle jet travels in the same direction as the core jet. With such a nozzle, a core jet of CO2 snow can be produced which has a mantle jet, of air or compressed air, surrounding same and can thus direct onto a working region a cleaning jet which is large enough to be able to effectively clean even larger surface areas. The core jet is preferably formed in that CO2 snow is formed by CO2 vaporization and, by the action of compressed air inside a CO2 pistol, is produced as a mixed jet of CO2 and compressed air with high speed when it emerges. Instead of compressed air, another gas can also be used. A core jet produced in this way is a mixed jet of CO2 snow and air or compressed air. This core jet is surrounded by a mantle jet of pure air which shields the core jet from external influences. The second discharge openings are particularly preferably formed such that air is sucked in over them and they then form a mantle jet which surrounds the core jet. This mantle jet can be produced in that air is entrained by the emerging core jet over the second discharge openings. Ambient air is particularly preferably used for this, i.e. the second discharge openings are provided with their distal end. The ambient air is thereby preferably entrained through these slits, is accelerated and evenly distributed around the core jet. This effect can preferably be further increased by a fitted-on venturi tube. Furthermore, a targeted feeding of the ambient air to the nozzle outlet prevents the nozzle tip from icing up. Alternatively a compressed air connection can be provided at these distal ends of the second discharge openings. In this way it is possible to clean, before a coating step, workpieces which are shortly to be moved past such a CO2 pistol with this nozzle by a transport device.

In a further advantageous embodiment of the present invention a tempering apparatus to control the temperature of the mantle jet of compressed air and/or of the core jet of CO2 snow is provided. By controlling the temperature, in particular of the mantle jet, it is possible to influence the geometry of the core jet. A temperature of the mantle jet of less than 10° C., particularly preferably of less than 4° C., is preferably used.

In a further advantageous embodiment of the present invention a control device is provided to set the speed of the mantle jet of compressed air and/or of the core jet of CO2 snow, in particular independently of each other. By setting the speed of the mantle jet the geometry of the core jet and thus the focus and the working region of the core jet can also be varied.

In a further advantageous embodiment of the present invention the first discharge opening for the core jet is formed as a Laval nozzle. By choosing the Laval nozzle the CO2 snow can be accelerated to very high speeds, particularly preferably ultrasonic speed, and thus leave the nozzle. The combination of this very high speed of the core jet on the one hand and the mantle jet of compressed air surrounding the core jet, which keeps disruptive influences away from the core jet, on the other hand, makes possible the use of the core jet over greater distances on the working region of a workpiece to be cleaned, whereby the cleaning of profiled parts and three-dimensional bodies also becomes possible.

In a further advantageous embodiment of the present invention feed means for the compressed air are provided within the nozzle in a section before the discharge openings guided parallel to feed means for the CO2 snow. This design measure makes possible a smaller overall height of the nozzle. In addition the forces are ideally absorbed in the nozzle and preferably aligned with the discharge direction of the two jets.

The object is also achieved by a carrousel for housing at least one nozzle according to the invention, comprising a rotation device which is formed such that the at least one nozzle can be moved in rotary movements over a working region. By using a carrousel, as is described for example also in the applicant's utility model DE 29814293 U1 for another field of use, the cleaning of even workpieces with undercuts can specifically be carried out even more efficiently. On such a carrousel, preferably at least one nozzle is arranged on a rotatable platform such that, when the rotation device is rotated a circle or an ellipse is described by the cleaning jet in a plane on the working region. The nozzle is particularly preferably set at an angle so that even undercuts can be cleaned, as the jet describes a conical section in the space in the direction of rotation of the rotation device and not just a cylinder. Through this angled alignment of the individual nozzle the workpiece is thus cleaned not only on the front but also from the side in the undercut region. The rotation device is particularly preferably driven by recoil forces of the jets emerging from the nozzle. In this way it is possible to save an additional drive for the rotation device. It is therefore also possible in an advantageous way, via a corresponding control device for the rotation device, to provide a special speed or speed patterns for the rotation device with which special geometries can then be cleaned particularly efficiently. Particularly preferably several nozzles, particularly preferably 3 nozzles, are provided on the carrousel or the rotation device. It is also advantageous to form the rotation device or the carrousel displaceable, even repeatedly, transversely to the conveyance direction of the workpiece to be machined, so that the carrousel or the rotation device can be moved to and fro perpendicular or at an angle to the conveyance direction for example of a conveyor belt on which the workpieces are deposited. A very complete working region is described in this way. The set angle of the individual nozzle of the carrousel is preferably also set differently here such that a large working region can be comprehensively and evenly coated due to the rotary movement of the individual nozzles on the one hand and the cross-movement of the whole carrousel on the other hand.

The object is also achieved by a method for the treatment, in particular cleaning, with CO2 snow of a workpiece to be coated, wherein a core jet of CO2 snow is directed at a speed of more than 200 m/s with a mantle jet, surrounding the core jet, of air, preferably compressed air onto the workpiece, wherein the mantle jet travels at a lower speed than the core jet. The core jet can be very well defined and applied constantly onto a workpiece over a greater distance by such a method in which the high-speed core jet of CO2 snow is again surrounded by a slower mantle jet of compressed air. Through the combination of a slower mantle jet of compressed air, all the disruptive influences which would change the geometry of the core jet are kept away. In this way the defined core jet of CO2 snow can be produced with parameters which are constant over great sections and can thus foreseeably also be applied to workpieces which have larger undercuts or are at a different distance from the cleaning nozzle.

In a further advantageous method of the present invention the speed of the mantle jet is less than 80%, preferably less than 75%, particularly preferably less than 50% of the speed of the core jet. It has been surprisingly found that the mantle jet produces a high shielding effect against disruptive influences even at clearly lower speeds than the core jet and contributes to the stabilization of the core jet. Thus the core jet can again act subject to less disruption on the workpiece.

In a further advantageous method of the present invention the ratio of the speed of the mantle jet to the speed of the core jet is adjustable. The geometry of the core jet is influenced by the choice of ratio of the speed of the mantle jet to the speed of the core jet. In this way it is possible to shape the jet of the core jet.

In a further advantageous method of the present invention the core jet has a speed of more than 333 m/s. By choosing the supersonic range for the core jet it is possible to achieve particularly high cleaning effects.

In a further advantageous method of the present invention the core jet has a diameter of 3.0 mm. The diameter of 30 mm is particularly preferably produced approx. 80 mm behind a nozzle end and this diameter kept constant for a further 200 to 300 mm. A variation of the diameter of the jet focus is for example possible by changing the speed of the mantle jet and/or through the choice of the temperature gradients between mantle stream and core stream.

In a further advantageous method of the present invention the external diameter of the mantle jet is approx. 200 to 250% of the diameter of the core jet.

In a further advantageous method of the present invention the geometry of the core jet is adjustable by varying the speed of the mantle jet.

In a further advantageous method of the present invention the mantle jet of compressed air has a higher temperature than the core jet of CO2 snow.

In a further advantageous method of the present invention the workpiece is coated after the treatment.

Advantageous designs and further embodiment examples are described in the attached drawings. There are shown in:

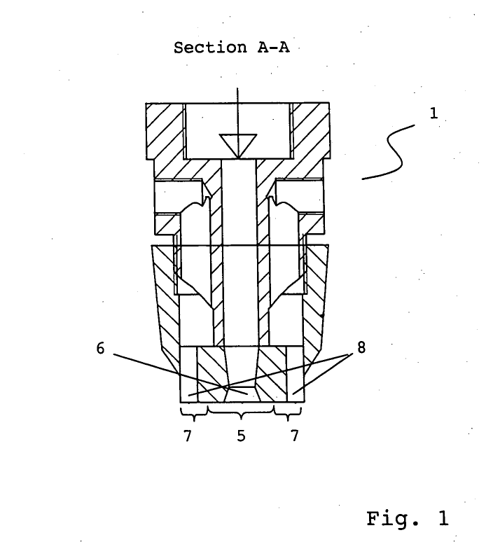

FIG. 1 a section view of an embodiment example of the nozzle according to the invention;

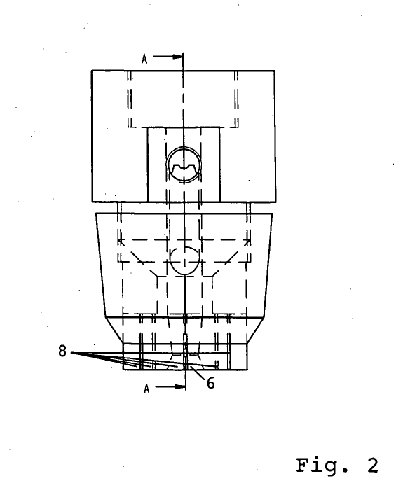

FIG. 2 an external view of an embodiment example of the nozzle according to the invention;

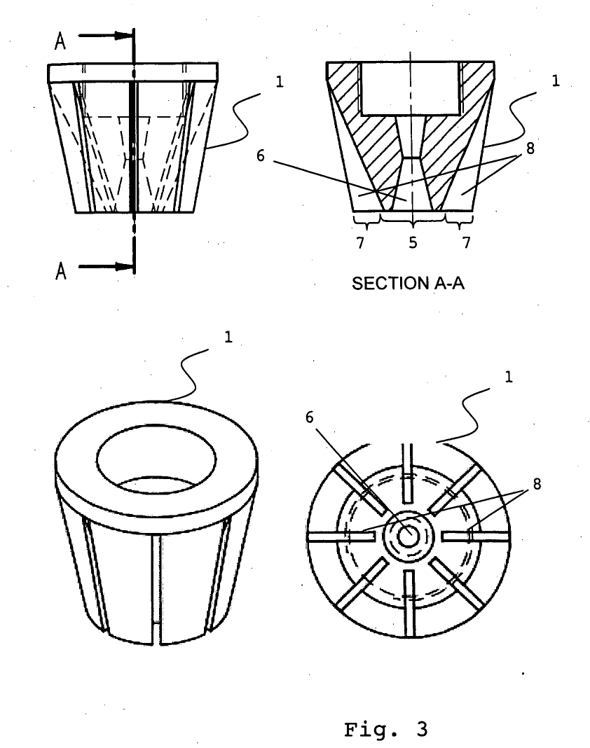

FIG. 3 a view of a second embodiment example of the nozzle according to the invention in four part-views;

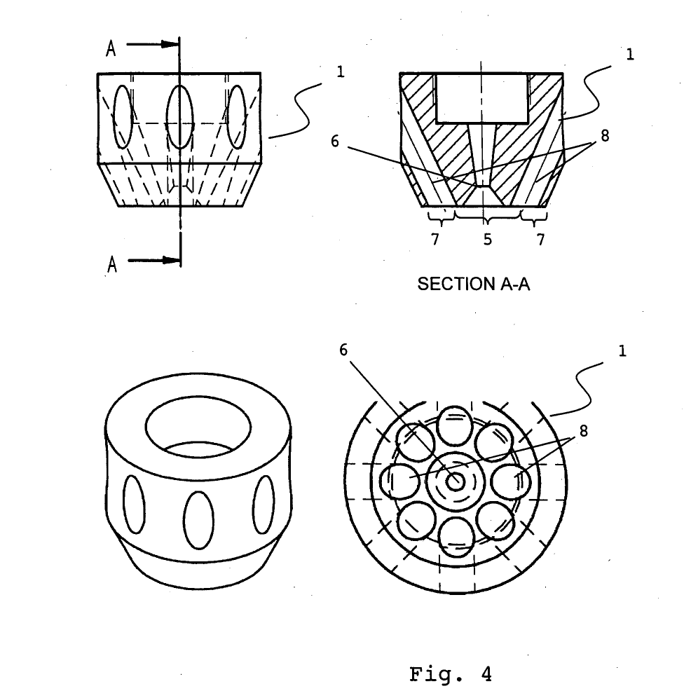

FIG. 4 a view of a third embodiment example of the nozzle according to the invention in four part-views;

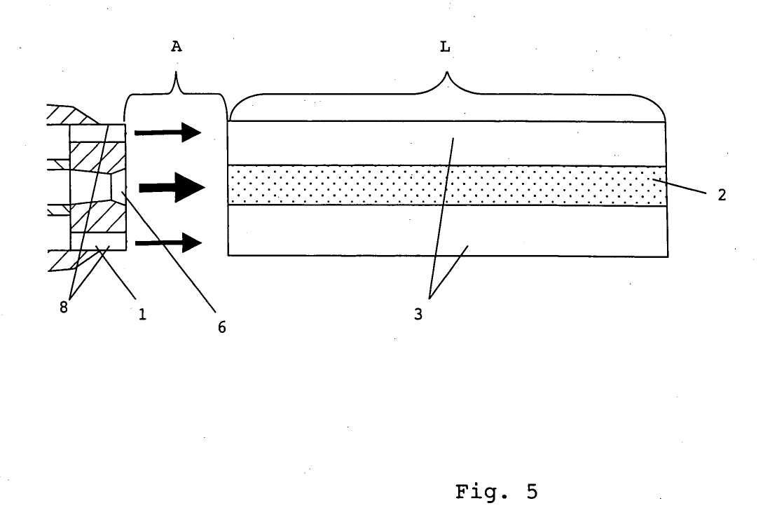

FIG. 5 a schematic representation of the core jet and of the mantle jet after emerging from a nozzle according to the invention; and

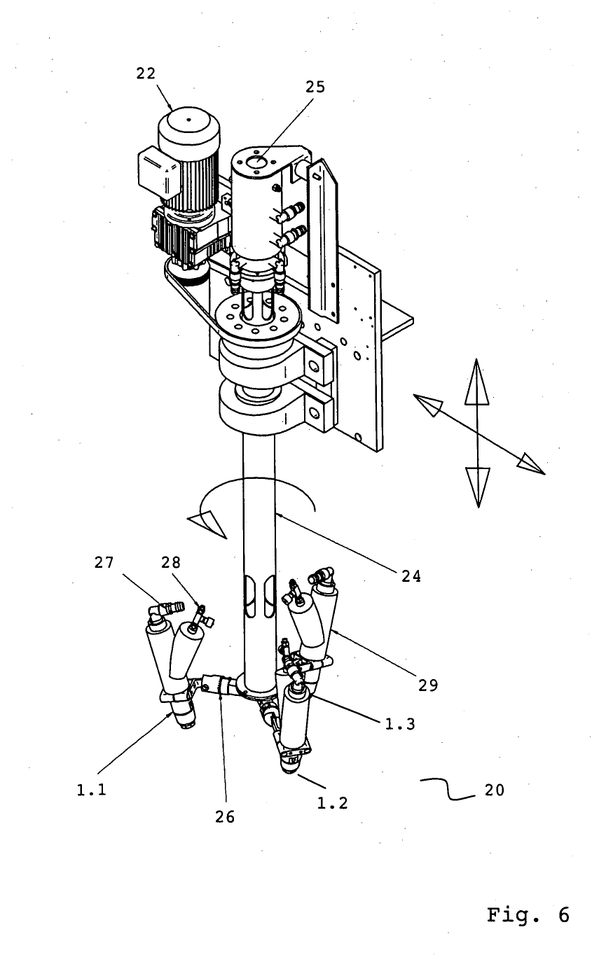

FIG. 6 a view of a carrousel according to the invention with nozzles according to the invention.

In FIG. 1 and also in FIG. 2 a section A-A along a nozzle according to the invention is represented. The nozzle 1 has a central conveying region for CO2 snow in the direction of the arrow. This duct opens out into a first discharge opening 6 which is located in a central region 5 of the nozzle 1. This central region is circular, just like the first discharge opening. Adjacent to this, a peripheral region 7 of the nozzle 1 is arranged circular about the central region 5 of the nozzle 1. In this peripheral region several slit-like second discharge openings 8 are provided from which compressed air can be transported. The feed lines for the compressed air are guided in the central section of the nozzle parallel to the central transport region for CO2 snow.

In operation, CO2 snow can be transported in the direction shown by the drawn-in arrow, emerging via the first discharge opening 6, shown as a Laval nozzle in the figure, at ultrasonic speed from the nozzle 1 in the central region of the nozzle 5. Compressed air is transported from the peripheral region 7 of the nozzle 1 through the various slits 8 and thus forms a mantle jet around the core jet evaporating in the central region.

In FIG. 2 the nozzle from FIG. 1 is illustrated again in a schematic overall view. Here can be seen in particular the slit-shaped second discharge openings 8 in the peripheral region 7 of the nozzle can be seen which are arranged around the first discharge opening 6 in the central region 5 of the nozzle. A mantle jet, uniformly surrounding the core jet, is formed by these slit-shaped discharge openings 8 which completely surrounds the CO2 snow core jet and can shield it from outside influences.

In FIG. 3 a view of a second embodiment example of the nozzle according to the invention in four part-views is represented. With this nozzle the peripheral region 7 is formed from slit-shaped discharge openings 8 which unlike in the case of the nozzle from FIGS. 1 and 2 are formed for the mantle jet air such that the distal ends of the discharge openings 8 are directly in contact with the ambient air. With this form of nozzle it is provided that the air for the mantle jet is sucked in from the ambient air via the slit-shaped discharge openings 8 and is entrained by the core jet which can emerge via the first discharge opening and the mantle jet thus forms about the core jet. This nozzle 1 preferably has eight slit-shaped discharge openings 8 which are arranged in a star pattern around the first discharge opening 6 of the nozzle or the central region 5 of the nozzle. Here the first discharge opening 6 advantageously has a Laval nozzle in order to define the core jet.

In FIG. 4 a view of a third embodiment example of the nozzle according to the invention in four part-views is represented. Here a geometry having ducts for the second discharge openings 8 is provided. Here the second discharge openings are arranged as ducts symmetrically around the first discharge opening 6 and are inclined towards the latter at an angle of 26 degrees. This angle is preferably between 40 degrees and 5 degrees, particularly preferably between 20 degrees and 30 degrees. Preferably eight ducts are provided here. Particularly preferably, slots of the nozzle form according to FIG. 3 can additionally be provided between the ducts or alternating, as an alternative to single ducts (not reproduced).

In FIG. 5 the emerging core jet 2 and the mantle jet 3 surrounding this is schematically represented over a length L. A mixture of CO2 snow and compressed air emerges as core jet 2 from the nozzle 1 at ultrasonic speed via the first discharge opening 6 in the direction of the central, thicker represented arrow. Alongside it a mantle jet 3 is produced with compressed air, compressed air emerging from the second discharge openings 8 of a lower speed than the core jet 2 and forming a mantle jet 3 about the core jet 2. At a distance A from the head of the nozzle, preferably approx. 80 mm, a region forms over a length L in which the diameter of the core jet 2 is kept largely constant and is surrounded by the mantle jet 3. The mantle jet 3 has a lower speed than the core jet 2. The length L is preferably approx. 200 to 500 mm, particularly preferably approx. 200 to 300 mm.

Through the choice of the speed ratio of the mantle jet 3 to the core jet 2, the geometry of the core jet 2 can be influenced in exactly the same way as by choosing the temperature of the mantle jet 3 with regard to the temperature of the core jet.

A carrousel according to the invention 20, on which three nozzles according to the invention 1 are mounted, is represented in FIG. 6.

A drive motor for rotation is formed by the drive 22, the power of which can be transmitted via a V-belt onto a rotating tube 24. The three nozzles 1.1 to 1.3 can be supplied through the rotating tube 24 via a rotary transmission leadthrough for compressed air and liquid CO2 with compressed air and liquid CO2.

The nozzles 1.1 to 1.3 consist of a CO2 snow jet pistol 29, fitted on top with an inlet 27 for compressed air and a further inlet 28 for CO2, shown here reproduced with a control valve. A pistol mounting 26 with integrated graduations is provided in order to perform reproducible settings of the direction of the jet.

The rotating tube 24 and thus the whole carrousel are rotated via the drive 22, so that the three nozzles 1.1 to 1.3 rotate about the rotation axis of the rotating tube. Through the setting of the jets which emerge from the nozzle, the direction of the jet can preferably be set via the pistol casing 26 such that the region to be treated is optimally covered on the workpiece. The rotation speed is controlled directly from the drive motor 22 by the V-belt provided between the drive motor 22 and the rotating tube 24. It would also be conceivable to provide a coupling such that only a basic speed is set via the drive motor and further speed components are supported by a recoil on the part of the jet from the nozzle. Particularly preferably it is possible to guide the whole carrousel again for example transversely over the workpiece or in the direction of the workpiece as shown by the represented arrow so that, in addition to the rotary movement of the carrousel, a transverse movement, for example a to and fro movement over the workpiece and/or onto the workpiece takes place so that the three rotating cleaning jets can again be applied more uniformly and comprehensively distributed over the region of the workpiece.

A nozzle for the directed delivery of CO2 snow and compressed air for the cleaning of workpieces and a method for same is thus provided by this invention, according to which a high level of cleaning performance, preferably for the pre-treatment of workpieces in a coating device, can be achieved to industrial scale over constant working regions.

### LIST OF REFERENCE NUMBERS

1 nozzle
2 core jet
3 mantle jet
5 central region of the nozzle
6 first discharge opening
7 peripheral region of the nozzle
8 second discharge opening
10 tempering apparatus
12 speed-control device
20 carrousel
22 drive
24 rotating tube for supply lines
25 rotary transmission leadthrough
26 pistol casing
27 compressed-air inlet
28 CO2 inlet
29 CO2 snow-jet pistol

1. A nozzle (1) for the directed delivery of CO2 snow and compressed air, characterized in that a central region (5) of the nozzle (1) has at least a first discharge opening (6) which is designed to produce a core jet (2) of CO2 snow at ultrasonic speed, wherein the central region (5) of the nozzle (1) is surrounded by a peripheral region (7) which has several second discharge openings (8) which are arranged around the first discharge opening (6) and are designed to produce a mantle jet (3), surrounding the core jet (2), of air at a lower speed than the core stream (2), wherein the mantle jet (3) travels in the same direction as the core jet (2).

2. The nozzle (1) according to claim 1, wherein a tempering apparatus (10) to control the temperature of the mantle jet (3) of air and/or the core jet (2) of CO2 snow is provided.

3. The nozzle (1) according to claim 1, wherein a control device (12) to set the speed of the mantle jet (3) of air and/or of the core jet (2) of CO2 snow, in particular independently of each other, is provided.

4. The nozzle (1) according to claim 1, wherein the first discharge opening (6) is formed as a Laval nozzle.

5. The nozzle (1) according to claim 1, wherein feed means for the air are provided within the nozzle (1) in a section before the discharge openings guided parallel to feed means for the CO2 snow.

6. A carrousel for housing at least one nozzle (1) according to claim 1, comprising a rotation device which is formed such that the at least one nozzle can be moved in rotary movements over a working region.

7. A method for the treatment, in particular cleaning, with CO2 snow of a workpiece to be coated, wherein a core jet (2) of CO2 snow is directed at a speed of more than 200 m/s with a mantle jet (3), surrounding the core jet (2), of air, onto the workpiece, characterized in that the mantle jet (3) travels at a lower speed than the core jet.

8. The method according to claim 7, wherein the speed of the mantle jet (3) is less than 80%, preferably less than 75%, particularly preferably less than 50% of the speed of the core jet (2).

9. The method according to claim 7, wherein the ratio of the speed of the mantle jet to the speed of the core jet (2) is adjustable.

10. The method according to claim 7, wherein the core jet (2) has a speed of more than 333 m/s.

11. The method according to claim 7, wherein the core jet (2) has a diameter of 30 mm.

12. The method according to claim 7, wherein the external diameter of the mantle jet (3) is 200 to 250% of the diameter of the core jet (2).

13. The method according to claim 7, wherein the geometry of the core jet (2) is adjustable by varying the speed of the mantle jet (3).

14. The method according to claim 7, wherein the mantle jet (3) of air has a higher temperature than the core jet (2) of CO2 snow.

15. The method according to claim 7, wherein the workpiece is coated after the treatment.

16. A method of using a nozzle (1) according to claim 1 to carry out a method according to claim 7.
